(19) United States
(12) Patent Application Publication
(10) Pub. No.: US 2003/0110075 A1
(43) Pub. Date: Jun. 12, 2003

(54) Toll collection system, its mobile terminal and toll processing apparatus, terminal processing program for the mobile terminal, and record medium recording the terminal processing program

(75) Inventors: Takehiko Shioda, Saitama (JP); Yukitaka Saito, Saitama (JP)

Correspondence Address: SUGHRUE MION, PLLC, 2100 PENNSYLVANIA AVENUE, N.W., WASHINGTON, DC, 20037, US

(73) Assignee: PIONEER CORPORATION

(21) Appl. No.: 10/308,068

(22) Filed: Dec. 3, 2002

(30) Foreign Application Priority Data
Dec. 12, 2001 (JP) P2001-378091

(51) Int. Cl. G06F 17/60

(52) U.S. Cl. 705/13

(57) ABSTRACT

To detect coming and going of an automobile 2 at gates 3 provided in the boundaries of a toll collection section and collect a toll from the automobile 2, the automobile 2 is provided with a navigation system 5 as a mobile terminal and a fixed unit group 7 is provided with fixed terminals 4 for communicating with the navigation system 5 and a toll collection apparatus 6 for calculating the toll of each automobile 2. Fuel economy data of the automobile 2 is transmitted from the navigation system 5 to the toll collection apparatus 6 and the toll responsive to the fuel economy data is imposed. If the driver drives the automobile so as to more lessen the emission amount of exhaust gas, the toll to be paid is reduced. Thus, it is made possible to insure improvement in the air quality.

### CROSS REFERENCE OF RELATED APPLICATION

This application is based on and claims priority under 35 U.S.C. §119 with respect to Japanese Patent Application No. 2001-378091 filed on Dec. 12, 2001, the entire content of which is incorporated herein by reference.

### BACKGROUND OF THE INVENTION

1. Field of the Invention

This invention relates to a toll collection system for collecting a toll from each vehicle entering a predetermined area to relieve traffic congestion, improve the air quality, etc., in the predetermined area, a mobile terminal and a toll processing apparatus of the toll collection system, a terminal processing program for the mobile terminal, and a record medium recording the terminal processing program.

2. Description of the Related Art

At present, in Tokyo, a toll collection system for collecting a toll from each automobile entering a predetermined area in which the concentration density of vehicles of trucks, passenger automobiles, autobicycles, etc., is high is examined to relieve traffic congestion, improve the air quality, etc., in the predetermined area (road pricing).

For example, the following plan is proposed: With Loop 7 as the boundary, the area inside Loop 7 is set as the predetermined area described above, a gate is placed at the intersection of a road extending to the inside of the area and Loop 7, each automobile passing through the inside and entering the area is detected at the gate, and a toll is collected from the automobile.

Here, the setup toll of an automobile varies depending on the type of automobile, such as a large automobile, a small automobile, or a low-emission vehicle.

In the toll collection system as described above, the same toll is imposed on the same automobile type regardless of whether the driver performs rough driving emitting a large amount of exhaust gas or gentle driving lessening the emission amount of exhaust gas and thus the driver cannot be prompted to drive so as to lessen the emission amount of exhaust gas as much as possible and it is feared that improvement in the air quality cannot be insured; this is a problem.

### SUMMARY OF THE INVENTION

It is an object of the invention to provide a toll collection system for making it possible to impose a toll responsive to how the driver drives a vehicle in a gentle manner in a predetermined area, a mobile terminal and a toll processing apparatus of the toll collection system, a terminal processing program for the mobile terminal, and a computer-readable record medium recording the terminal processing program.

According to a first aspect of the invention, there is provided a toll collection system wherein gates are placed in the boundaries of a predetermined area and a vehicle passing through the inside and entering the area is detected at the gate for collecting a toll from the vehicle, the toll collection system comprising fixed terminals each being placed in the proximity of each gate and capable of communicating with a mobile unit passing through the vicinity thereof; a mobile terminal being installed in a vehicle for collecting run data used as an index indicating the magnitude of the effect on the environment as the vehicle runs from the vehicle and transmitting the run data to the fixed terminal; and a toll processing apparatus for receiving the run data of each vehicle through the fixed terminal and calculating the toll of each vehicle based on the received run data.

As the run data used as the index indicating the magnitude of the effect on the environment as the vehicle runs, the fuel economy of the vehicle (fuel consumption rate), the emission amount of environmental pollutants and the emission amount of greenhouse gases produced as the vehicle runs, and the like can be adopted.

In the first aspect of the invention, the toll responsive to the run data of the fuel economy of the vehicle (fuel consumption rate), the emission amount of environmental pollutants and the emission amount of greenhouse gases produced as the vehicle runs, and the like is imposed on the vehicle and if the driver drives the vehicle so as to emit a larger amount of exhaust gas, the toll to be paid is raised; in contrast, if the driver drives the vehicle so as to more lessen the emission amount of exhaust gas, the toll to be paid is reduced. Thus, the driver can be prompted to drive so as to lessen the effect on the environment as the vehicle runs as much as possible, and it is made possible to insure improvement in the air quality.

In the described toll collection system, preferably the mobile terminal collects traveled distance data and fuel consumption amount data from the vehicle, calculates fuel economy data of the vehicle from the traveled distance data and the fuel consumption amount data, and transmits the fuel economy data to the fixed terminal as the run data, and the toll processing apparatus comprises a standard fuel economy database recording standard fuel economy data under a standard run condition found for each model of vehicle, compares the fuel economy data from each vehicle with the standard fuel economy data of the vehicle, and calculates the toll of the vehicle based on the comparison result.

To collect the traveled distance data and the fuel consumption amount data from the vehicle, the traveled distance data can be easily taken out from a speed meter, etc., and the fuel consumption amount data can be easily taken out from a fuel injection system, a fuel meter, etc., so that remolding of the vehicle to collect the data can be minimized.

If the fuel economy data is referenced, the emission amount of environmental pollutants and the emission amount of greenhouse gases discharged from the vehicle as the vehicle runs can be grasped and the magnitude of the effect on the environment as the vehicle runs can be easily converted into a numerical value.

Thus, in doing so, an appropriate toll can be calculated without raising the price of the vehicle fitted for the toll collection system or the remolding cost to fit the vehicle for the toll collection system.

In the described toll collection system, preferably the mobile terminal comprises a navigation system for receiving current position information to measure the current position of the mobile unit and displaying the current position on a screen of a display based on stored map information.

Since a microprocessor that can perform various operations at high speed is installed in the navigation system, as described above, if the navigation system is used, the collection function of the traveled distance data and the fuel consumption amount data, the calculation function of calculating the fuel economy data from the traveled distance data and the fuel consumption amount data, the transmission function of the fuel economy data, and the like can be provided easily and moreover, vehicle-installed navigation systems are widespread and thus from this point, the price of the vehicle fitted for the toll collection system and the remolding cost to fit the vehicle for the toll collection system are not raised.

Further, in the described toll collection system, preferably the navigation system comprises a route search unit for making a search for a route to a destination, a fuel economy prediction unit for predicting the fuel economy by calculating when running on the route for each found route, and a low fuel consumption route search unit for making a search for a low fuel consumption route based on the prediction result of the fuel economy prediction unit.

In doing so, the navigation system finds out a low fuel consumption route, namely, a route lessening the effect on the environment as the vehicle runs, and shows the low fuel consumption route for the driver. If the driver drives the vehicle in accordance with the route indicated by the navigation system, it is made possible to still more insure improvement in the air quality.

In the toll collection system, preferably the navigation system comprises a predicted fuel economy transmission unit for transmitting the predicted fuel economy data provided by calculating by the fuel economy prediction unit to the toll processing apparatus, and the toll processing apparatus comprises a tentative toll transmission unit for receiving the predicted fuel economy data, calculating a tentative toll based on the received predicted fuel economy data, and transmitting the calculated tentative toll to the navigation system.

In doing so, the navigation system makes a search for a plurality of low fuel consumption routes, the toll processing apparatus calculates the tentative toll for each of the routes, and the low fuel consumption routes can be presented for the driver. The driver selects the lowest-toll route, in other words, the route with the smallest effect on the environment as the vehicle runs unless a special situation or reason exists. Thus, it is made possible to still more insure improvement in the air quality.

According to a second aspect of the invention, there is provided a mobile terminal installed in a toll collection system wherein gates are placed in the boundaries of a predetermined area and a vehicle passing through the inside and entering the area is detected at the gate for collecting a toll from the vehicle, the toll collection system comprising fixed terminals each being placed in the proximity of each gate and capable of communicating with a mobile unit passing through the vicinity thereof, and a toll processing apparatus for receiving run data used as an index indicating the magnitude of the effect on the environment as the vehicle runs through the fixed terminal and calculating the toll of the vehicle based on the received run data, the mobile terminal being installed in a vehicle for collecting the run data of the vehicle and transmitting the run data to the fixed terminal.

In the second aspect of the invention, as in the first aspect of the invention, the toll responsive to the run data is imposed on the vehicle and if the driver drives the vehicle so as to emit a larger amount of exhaust gas, the toll to be paid is raised; in contrast, if the driver drives the vehicle so as to more lessen the emission amount of exhaust gas, the toll to be paid is reduced. Thus, the driver can be prompted to drive so as to lessen the effect on the environment as the vehicle runs as much as possible, and it is made possible to insure improvement in the air quality.

In the described mobile terminal, preferably the toll processing apparatus comprises a standard fuel economy database recording standard fuel economy data under a standard run condition found for each model of vehicle, compares the fuel economy data from each vehicle with the standard fuel economy data of the vehicle, and calculates the toll of the vehicle based on the comparison result, and the mobile terminal collects traveled distance data and fuel consumption amount data from the vehicle, calculates fuel economy data of the vehicle from the traveled distance data and the fuel consumption amount data, and transmits the fuel economy data to the fixed terminal as the run data.

In doing so, as described above, remolding of the vehicle to collect the traveled distance data and the fuel consumption amount data can be minimized, so that an appropriate toll can be calculated without raising the price of the vehicle fitted for the toll collection system or the remolding cost to fit the vehicle for the toll collection system.

The described mobile terminal preferably comprises a navigation system for receiving current position information to measure the current position of the mobile unit and displaying the current position on a screen of a display based on stored map information.

In doing so, as described above, the navigation system can easily provide the collection function of the traveled distance data and the fuel consumption amount data, the calculation function of calculating the fuel economy data from the traveled distance data and the fuel consumption amount data, the transmission function of the fuel economy data, and the like and moreover, vehicle-installed navigation systems are widespread and thus from this point, the price of the vehicle fitted for the toll collection system and the remolding cost to fit the vehicle for the toll collection system are not raised.

Further, in the described mobile terminal, preferably the navigation system comprises a route search unit for making a search for a route to a destination, a fuel economy prediction unit for predicting the fuel economy by calculating when running on the route for each found route, and a low fuel consumption route search unit for making a search for a low fuel consumption route based on the prediction result of the fuel economy prediction unit.

In doing so, as described above, the navigation system finds out a low fuel consumption route, namely, a route lessening the effect on the environment as the vehicle runs, and shows the low fuel consumption route for the driver, so that the driver drives the vehicle in accordance with the route, whereby it is made possible to still more insure improvement in the air quality.

In the mobile terminal, preferably the toll processing apparatus comprises a tentative toll transmission unit for calculating a tentative toll based on the predicted fuel economy data calculated by the navigation system and transmitting the calculated tentative toll to the navigation system, and the navigation system comprises a predicted fuel economy transmission unit for transmitting the predicted fuel economy data provided by calculating by the fuel economy prediction unit to the toll processing apparatus.

In doing so, as described above, the toll processing apparatus calculates the tentative toll for each of a plurality of low fuel consumption routes found by the navigation system, and the low fuel consumption routes are presented for the driver. Thus, the driver selects the lowest-toll route, in other words, the route with the smallest effect on the environment as the vehicle runs unless a special situation or reason exists, and it is made possible to still more insure improvement in the air quality.

According to a third aspect of the invention, there is provided a toll processing apparatus installed in a toll collection system wherein gates are placed in the boundaries of a predetermined area and a vehicle passing through the inside and entering the area is detected at the gate for collecting a toll from the vehicle, the toll collection system comprising fixed terminals each being placed in the proximity of each gate and capable of communicating with a mobile unit passing through the vicinity thereof, and a mobile terminal being installed in a vehicle for collecting run data used as an index indicating the magnitude of the effect on the environment as the vehicle runs from the vehicle and transmitting the run data to the fixed terminal, the toll processing apparatus for receiving the run data of each vehicle through the fixed terminal and calculating the toll of each vehicle based on the received run data.

In the third aspect of the invention, as in the first and second aspects of the invention, the toll responsive to the run data is imposed on the vehicle and if the driver drives the vehicle so as to emit a larger amount of exhaust gas, the toll to be paid is raised; in contrast, if the driver drives the vehicle so as to more lessen the emission amount of exhaust gas, the toll to be paid is reduced. Thus, the driver can be prompted to drive so as to lessen the effect on the environment as the vehicle runs as much as possible, and it is made possible to insure improvement in the air quality.

In the described toll processing apparatus, preferably the mobile terminal collects traveled distance data and fuel consumption amount data from the vehicle, calculates fuel economy data of the vehicle from the traveled distance data and the fuel consumption amount data, and transmits the fuel economy data to the fixed terminal as the run data, and the toll processing apparatus comprises a standard fuel economy database recording standard fuel economy data under a standard run condition found for each model of vehicle, compares the fuel economy data from each vehicle with the standard fuel economy data of the vehicle, and calculates the toll of the vehicle based on the comparison result.

In doing so, as described above, remolding of the vehicle to collect the traveled distance data and the fuel consumption amount data can be minimized, so that an appropriate toll can be calculated without raising the price of the vehicle fitted for the toll collection system or the remolding cost to fit the vehicle for the toll collection system.

In the described toll processing apparatus, preferably the mobile terminal comprises a navigation system for receiving current position information to measure the current position of the mobile unit and displaying the current position on a screen of a display based on stored map information, the navigation system comprises a route search unit for making a search for a route to a destination, a fuel economy prediction unit for predicting the fuel economy by calculating when running on the route for each found route, a low fuel consumption route search unit for making a search for a low fuel consumption route based on the prediction result of the fuel economy prediction unit, and a predicted fuel economy transmission unit for transmitting the predicted fuel economy data provided by calculating by the fuel economy prediction unit to the toll processing apparatus, and the toll processing apparatus comprises a tentative toll transmission unit for receiving the predicted fuel economy data, calculating a tentative toll based on the received predicted fuel economy data, and transmitting the calculated tentative toll to the navigation system.

In doing so, as described above, the navigation system makes a search for a plurality of low fuel consumption routes and presents the low fuel consumption routes for the driver, the toll processing apparatus calculates the tentative toll for each of the low fuel consumption routes found by the navigation system, and the low fuel consumption routes are presented for the driver. Thus, the driver selects the lowest-toll route, in other words, the route with the smallest effect on the environment as the vehicle runs unless a special situation or reason exists, and it is made possible to still more insure improvement in the air quality.

According to a fourth aspect of the invention, there is provided a terminal processing program for a mobile terminal being installed in a vehicle for transmitting predetermined run data to a toll processing apparatus placed in a toll collection system wherein gates are placed in the boundaries of a predetermined area and a vehicle passing through the inside and entering the area is detected at the gate for collecting a toll from the vehicle, the mobile terminal including a computer, the terminal processing program for causing the computer to function as a collection unit for collecting traveled distance data and fuel consumption amount data from the vehicle; a fuel economy calculation unit for calculating fuel economy data of the vehicle from the traveled distance data and the fuel consumption amount data collected by the collection unit; and a data transmission unit for transmitting the fuel economy data calculated by the fuel economy calculation unit to the toll processing apparatus as the run data.

According to a fifth aspect of the invention, there is provided a record medium recording the terminal processing program for the mobile terminal in the fourth aspect of the invention.

If the terminal processing program according to the fourth aspect of the invention as described above is installed in a small-sized computer, the above-described mobile terminal can be easily implemented. In addition, the record medium according to the fifth aspect of the invention enables the terminal processing program to be easily installed in a small-sized computer and moreover to be installed repeatedly; it also becomes easy to manufacture a large number of mobile terminals having the same function.

Moreover, as described above, remolding of the vehicle to collect the traveled distance data and the fuel consumption amount data can be minimized, so that if the vehicle is fitted for the toll collection system, the price of the vehicle and the remolding cost of the vehicle are not raised.

In the described terminal processing program for the mobile terminal, preferably the mobile terminal including the computer is a navigation system for receiving current position information to measure the current position of the mobile unit from the outside and displaying the current position on a screen of a display based on previously stored map information, the terminal processing program for causing the computer of the navigation system to function as a route search unit for making a search for a route to a destination; a fuel economy prediction unit for predicting the fuel economy by calculating when running on the route for each found route; a low fuel consumption route search unit for making a search for a low fuel consumption route based on the prediction result of the fuel economy prediction unit; and a predicted fuel economy transmission unit for transmitting the predicted fuel economy data provided by calculating by the fuel economy prediction unit to the toll processing apparatus.

If the terminal processing program is installed in the navigation system, the mobile terminal comprising the low fuel consumption route search unit for making a search for a low fuel consumption route and a predicted fuel economy transmission unit for transmitting the predicted fuel economy data provided by calculating by the fuel economy prediction unit to the toll processing apparatus can be implemented easily.

Preferably, the terminal processing program for the mobile terminal is recorded on the record medium according to the fifth aspect of the invention.

The record medium enables the terminal processing program to be easily installed in the navigation system. In addition, for a vehicle having only the navigation function for which initially the function of making a search for a low fuel consumption route and the like are not required, when the function of making a search for a low fuel consumption route or the like becomes necessary for the vehicle, if the terminal processing program is installed in the navigation system, the mobile terminal is installed, so that it is made possible to minimize the remolding cost for installing the mobile terminal.

### BRIEF DESCRIPTION OF THE DRAWINGS

FIG. 1 is a schematic drawing to show the whole system configuration of a first embodiment of the invention;

FIG. 2 is a block diagram to show a navigation system of the first embodiment of the invention;

FIG. 3 is a block diagram to show a control section of the navigation system of the first embodiment of the invention;

FIG. 4 is a block diagram to show a fuel economy data preparation processing section of the first embodiment of the invention;

FIG. 5 is a block diagram to show a toll collection apparatus of a toll processing apparatus of the first embodiment of the invention;

FIG. 6 is a drawing to show a standard fuel economy database of the first embodiment of the invention;

FIG. 7 is a sequence chart to describe the whole operation of the first embodiment of the invention;

FIG. 8 is a flowchart to show the operation of a mobile terminal of the first embodiment of the invention;

FIG. 9 is a flowchart to show the operation of the toll collection apparatus of the first embodiment of the invention;

FIG. 10 is a sequence chart to describe the whole operation of a second embodiment of the invention;

FIG. 11 is a flowchart to show the operation of a mobile terminal of the second embodiment of the invention; and

FIG. 12 is a flowchart to show the operation of a toll collection apparatus of the second embodiment of the invention.

### DETAILED DESCRIPTION OF THE PREFERRED EMBODIMENTS

Referring now to the accompanying drawings, there are shown preferred embodiments of the invention.

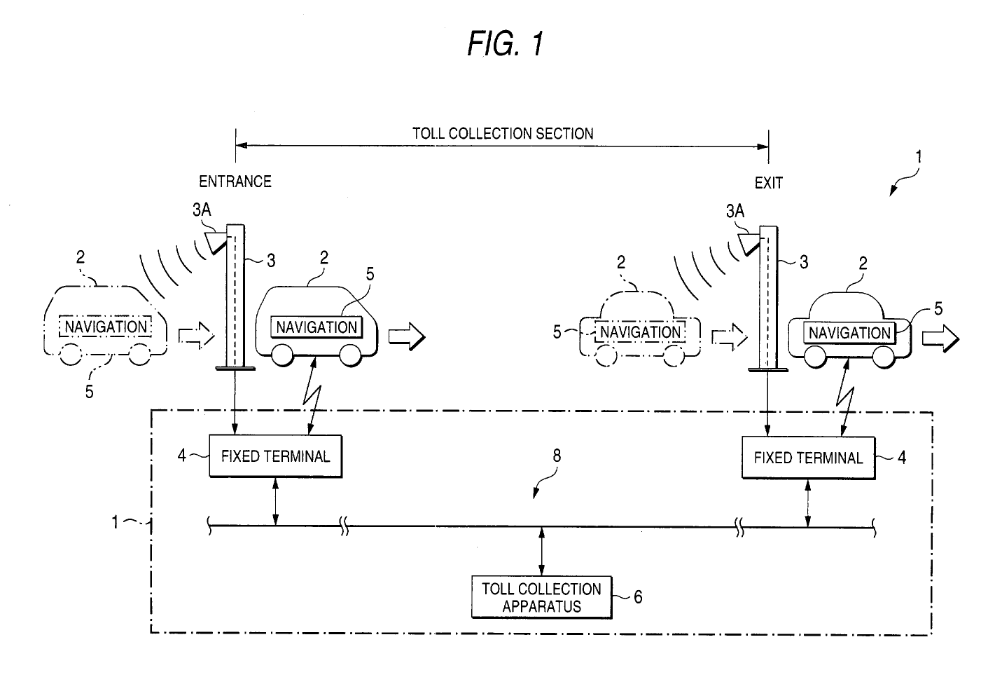

FIG. 1 shows an outline of a toll collection system 1 according to a first embodiment of the invention. This toll collection system 1 is a road pricing system of a codon system to collect a toll from each automobile 2 of a truck, a passenger automobile, etc., as a vehicle when the automobile 2 passes through a toll collection section of a predetermined area in which the passage of the automobile 2 is charged.

The toll collection system 1 adopts a system similar to ETC (Electronic Toll Collection) for freeways, etc., as a system for colleting a toll.

As shown in FIG. 1, the toll collection system 1 comprises, a plurality of gates 3 placed in the boundaries of the toll collection section, fixed terminals 4 each being placed in the proximity of each gate 3, navigation systems 5 of mobile terminals for collecting run data of the automobiles 2 from the automobiles 2, and a toll collection apparatus 6 for calculating and collecting the toll of each automobile 2.

The navigation system 5 is a mobile terminal comprising a communication function of transmitting the collected run data to the nearby fixed terminal 4 and having an identification number previously registered in the toll collection system 1. When the navigation system 5 is installed in the automobile 2, necessary data is recorded in the navigation system 5 and accordingly the corresponding automobile 2 is also registered in the toll collection system 1.

On the other hand, the fixed terminal 4 is a kind of relay unit capable of communicating with the navigation system 5, a mobile unit, installed in the automobile 2 passing through the gate 3; the fixed terminals 4, the gates 3, the toll collection apparatus 6, and the like make up a fixed side unit group 7.

The toll collection apparatus 6 is a toll processing apparatus which is connected to the fixed terminals 4 by a digital communication line 8, can receive run data of each automobile 2 through the fixed terminal 4, and calculates the toll of the automobile 2 based on the received run data.

The gate 3 comprises a proximity sensor 3A for detecting the automobile 2 approaching the gate 3 and transmits an automobile detection signal output from the proximity sensor 3A to the fixed terminal 4. Upon reception of the automobile detection signal from the proximity sensor 3A, the fixed terminal 4 starts to communicate with the navigation system 5.

The navigation system 5 is a computer comprising a microprocessor, etc., and comprises a multitask function of processing a plurality of programs concurrently.

The navigation system 5 also collects run data used as an index indicating the magnitude of the effect on the environment as the automobile 2 runs from the automobile 2. That is, the navigation system 5 collects the traveled distance data and the fuel consumption amount data from the automobile 2, calculates fuel economy data of the automobile 2 from the data, and transmits the fuel economy data to the fixed terminal 4 as run data.

The navigation system 5 comprises a current position display function of receiving current position information for measuring the current position of the automobile 2 and displaying the current position on a screen of a display based on stored map information for the driver, etc., of the automobile 2, and a route search function of making a search for a route considered to be optimum for arriving at the entered destination.

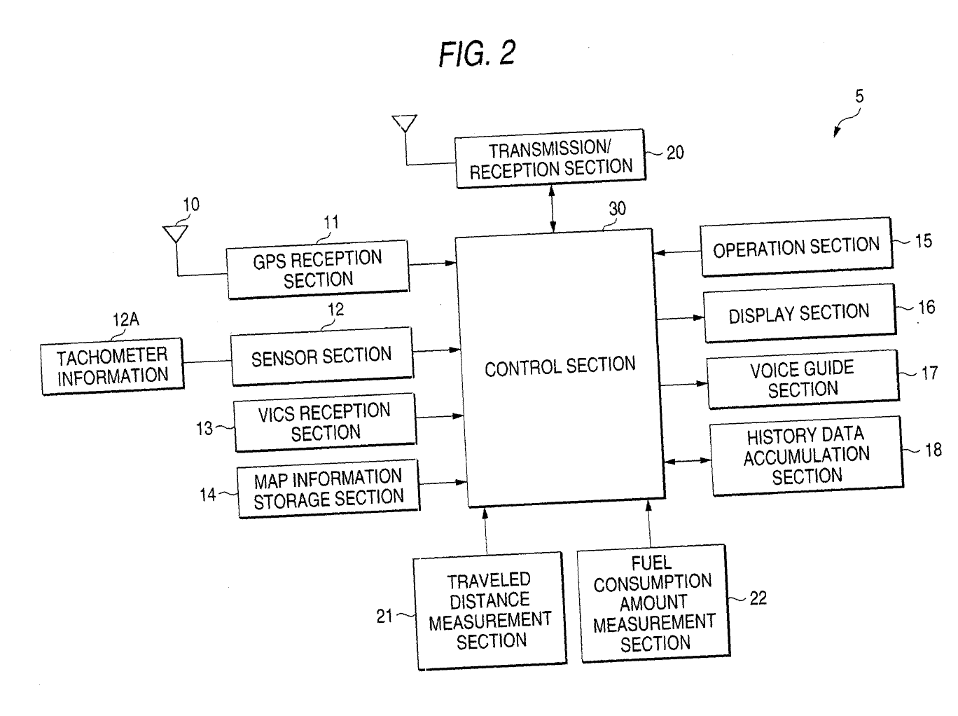

That is, as shown in FIG. 2, the navigation system 5 comprises an antenna 10 for receiving a radio signal containing data concerning the three-dimensional position, speed, and time, transmitted from an artificial satellite of GPS, a GPS reception section 11 for taking out the data concerning the three-dimensional position, etc., of the automobile 2 from the radio signal received at the antenna 10, a sensor section 12 comprising various sensors such as a sensor for sensing the run speed of the automobile 2, a VICS reception section 13 for receiving VICS information, a map information storage section 14 for storing map information, an operation section 15 for performing manual operation, a display section 16 for displaying the map information and the position of the vehicle, a voice guide section 17 for guiding the driver to a route by voice, a history data accumulation section 18 for accumulating history data concerning routes, such as the routes found by the navigation system 5 and the time required when the automobile 2 actually runs on each route, and a control section 30 for controlling the whole navigation system 5.

The GPS reception section 11 receives radio signals from a plurality of artificial satellites of the GPS, extracts the position data indicating the three-dimensional position of the automobile 2 at the current point in time and the time data indicating the precise time from the radio signals, and outputs the extracted data to the control section 30.

The sensor section 12 comprises a speed sensor for detecting the run speed of the automobile 2, a gravitational acceleration sensor for detecting gravitational acceleration, an acceleration sensor for detecting the acceleration occurring as the automobile 2 runs, and an azimuth sensor comprising a gyro sensor for detecting the azimuth of the automobile 2 in the traveling direction thereof.

When the speed sensor detects the run speed of the automobile 2, the sensor section 12 generates speed data responsive to the detected run speed and outputs the speed data to the control section 30.

When the gravitational acceleration sensor detects the gravitational acceleration and the acceleration sensor detects the acceleration occurring as the automobile 2 runs, the sensor section 12 compares the detected gravitational acceleration with the detected acceleration, calculates the speed of the automobile 2 in the gravity direction thereof, generates gravity direction speed data responsive to the calculated gravity direction speed, and outputs the gravity direction speed data to the control section 30.

Further, when the azimuth sensor detects the azimuth of the automobile 2, the sensor section 12 generates azimuth data responsive to the detected azimuth and outputs the azimuth data to the control section 30.

A number-of-revolutions collection section 12A for collecting the engine speed of the automobile 2 from a tachometer (not shown) is connected to the sensor section 12. Thus, the control section 30 receives the engine speed through the sensor section 12 and can detect operation adversely affecting the environment, such as the engine at idle.

The VICS reception section 13 extracts road traffic data concerning traffic congestion, traffic control caused by construction, etc., in a wide range from a radio signal of FM multiplex broadcast conducted by the VICS center or the like, and outputs the road traffic data to the control section 30.

The map information storage section 14 comprises a disk drive for reading map information recorded on a record medium such as a DVD-ROM (Digital Versatile Disc Read-Only Memory) or a CD-ROM (Compact Disc Read-Only Memory).

The map information storage section 14 stores three-dimensional map information, namely, map information containing the height above the sea level of each point on a map and information required for a move of the automobile, for example, information such as section information indicating that a predetermined section on the map is a regulation section blocked to an automobile driven by an internal combustion engine such as a gasoline engine or a diesel engine.

The operation section 15 comprises a remote control comprising different types of keys such as a plurality of function keys for performing various types of operation and numeric keys of 0 to 9.

The display section 16 displays a guide screen based on the map information output from the map information storage section 14. The guide screen of the display section 16 displays information concerning the forward road circumstances in the traveling direction, the destination, etc., as well as a pointer pointing to the traveling direction.

The voice guide section 17 indicates by voice the traveling direction at each point where the direction is to be changed before the automobile reaches the point where the direction is to be changed, for example, an interchange or a junction of a freeway, a toll road, etc., or an intersection, etc., of a general road.

The history data accumulation section 18 stores history data containing route information concerning setting, a destination, a departure point, a route, and road data on the route entered in the navigation system 5 by the user of the driver, etc., and time information concerning the date and time. As the history data containing the route information and the time information is accumulated, a navigation history database is constructed in the history data storage section 18.

The navigation system 5 also comprises a transmission/reception section 20 for communicating with the toll collection apparatus 6 through the fixed terminal 4 to function as a mobile terminal, a traveled distance measurement section 21 for receiving a traveled distance unit pulse of the traveled distance data output from an odometer, etc., of the automobile 2 and measuring the traveled distance, and a fuel consumption amount measurement section 22 for receiving a fuel consumption unit pulse of the fuel consumption amount data output from a fuel injection system, etc., and measuring the fuel consumption amount.

The traveled distance measurement section 21 and the fuel consumption amount measurement section 22 start measurement upon reception of an entry signal transmitted from the fixed terminal 4 when the automobile 2 enters the toll collection section and on the other hand, terminates measurement upon reception of an exit signal transmitted from the fixed terminal 4 when the automobile 2 exits from the toll collection section.

The control section 30 performs navigation processing for guiding the driver, etc., of the automobile 2 to a route and fuel economy data generation processing for generating the fuel economy data described above and predicted fuel economy data described later, transmitted to the fixed terminal 4.

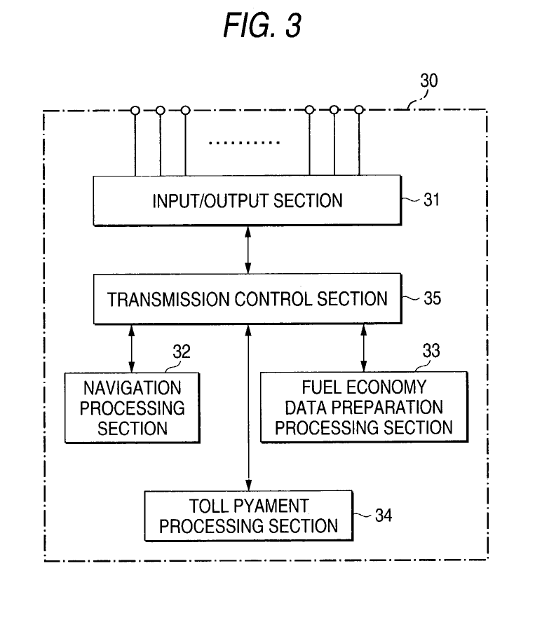

As shown in FIG. 3, the control section 30 is provided with an input/output section 31 to input/output data and command signals from/to the GPS reception section 11, the sensor section. 12, the VICS reception section 13, the map information storage section 14, the operation section 15, the display section 16, the voice guide section 17, the history data accumulation section 18, the transmission/reception section 20, the traveled distance measurement section 21, and the fuel consumption amount measurement section 22. The control section 30 is also provided with a navigation processing section 32 for performing navigation processing, a fuel economy data preparation processing section 33 for preparing run data, a toll payment processing section 34 for performing toll payment processing to the toll collection system 1, and a transmission control section 35 for controlling transmission of data among the input/output section 31, the navigation processing section 32, the fuel economy data preparation processing section 33, and the toll payment processing section 34.

The navigation processing section 32 comprises a route search function of making a search for a plurality of routes on which the automobile seems to be able to earliest arrive at the destination from the current point as candidates considering the road traffic data concerning traffic congestion, traffic control caused by construction, etc., from the VICS reception section 13, and a route information extraction function of extracting a route information signal concerning the route from the current point to the destination from the map information in the map information storage section 14.

The route information signal contains not only information concerning the move distance in the horizontal direction, but also information concerning the move distance in the gravity direction, namely, the move distance in the climbing direction and the move distance in the down direction and road traffic information concerning the delay time caused by traffic congestion, traffic control caused by construction, etc.

The fuel economy data preparation processing section 33 predicts the fuel economy of the automobile 2 in each toll collection section by a computation program containing a predetermined algorithm and operational expression when the route information signal is input.

Upon reception of the entry signal transmitted from the fixed terminal 4 when the automobile 2 enters the toll collection section, the toll payment processing section 34 transmits the identification number registered in the toll collection system 1 to the toll collection apparatus 6.

Upon reception of toll data transmitted by the toll collection apparatus 6 through the fixed terminal 4 when the automobile 2 exits from the toll collection section, the toll payment processing section 34 performs payment processing. As the payment processing, for example, payment processing of transmitting a payment code for causing a predetermined credit company, etc., to pay the toll to the toll collection apparatus 6 or the like can be adopted.

The fuel economy data preparation processing section 33 comprises a fuel economy calculation function of calculating the fuel economy when the automobile actually passes through the toll collection section, a fuel economy prediction function of predicting the fuel economy when the automobile runs on the route by calculating for each route found by the navigation processing section 32, and a route selection function of requesting the driver, etc., to select one from among the found routes.

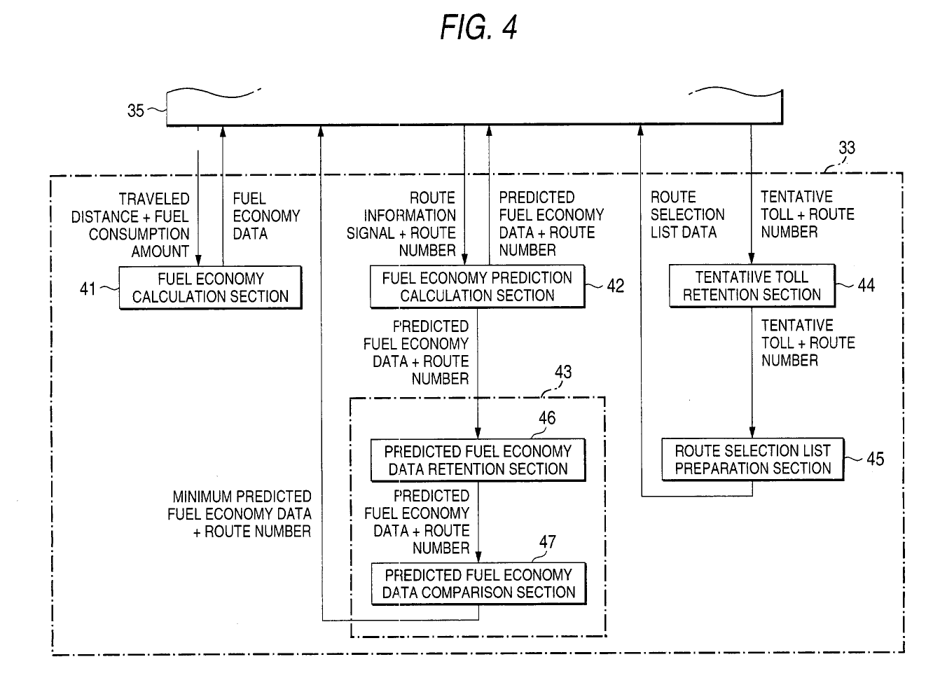

As shown in FIG. 4, the fuel economy data preparation processing section 33 comprises a fuel economy calculation section 41 for calculating the fuel economy in the toll collection section based on the actual traveled distance and fuel consumption amount, a fuel economy prediction calculation section 42 of a fuel economy prediction unit for predicting the fuel economy in the toll collection section by calculating, a low fuel consumption route search section 43 of a low fuel consumption route search unit for making a search for the lowest fuel consumption route based on the prediction result of the fuel economy prediction calculation section 42, a tentative toll retention section 44 for retaining a tentative toll (described later) calculated by the toll collection apparatus 6 based on the predicted fuel economy data of the fuel economy predicted by the fuel economy prediction calculation section 42, and a route selection list preparation section 45 for preparing a tentative toll list for the selecter of the driver, etc., to select one from among a plurality of routes.

The fuel economy calculation section 41 receives the traveled distance measured by the traveled distance measurement section 21 and the fuel consumption amount measured by the fuel consumption amount measurement section 22 and divides the traveled distance by the fuel consumption amount, thereby calculating the fuel economy. The fuel economy data of the fuel economy calculated by the fuel economy calculation section 41 is transmitted to the toll collection apparatus 6.

The fuel economy prediction calculation section 42 predicts the fuel economy of the automobile 2 in the toll collection section by calculating based on each route information signal extracted by the navigation processing section 32, for example, data of the move distance in the horizontal direction, the move distance in the climbing direction, the move distance in the down direction, the delay time, and the like. The predicted fuel economy data provided by the fuel economy prediction calculation section 42 is transmitted to the toll collection apparatus 6.

The transmission/reception section 20 (see FIG. 2) connected to the control section 30 also serves as a predicted fuel economy transmission unit for transmitting the predicted fuel economy data provided by calculating by the fuel economy prediction calculation section 42 to the toll collection apparatus 6.

Upon reception of the predicted fuel economy data, the toll collection apparatus 6 calculates a tentative toll based on the predicted fuel economy data and transmits the tentative toll to the fuel economy data preparation processing section 33.

The low fuel consumption route search section 43 indicates the lowest fuel consumption route of a plurality of routes extracted by the navigation processing section 32.

The low fuel consumption route search section 43 is provided with a predicted fuel economy data retention section 46 for retaining all the predicted fuel economy data of the prediction result of the fuel economy prediction calculation section 42 for the routes and a predicted fuel economy data comparison section 47 for comparing the predicted fuel economy data retained in the predicted fuel economy data retention section 46 with each other.

From the fuel economy prediction calculation section 42, the predicted fuel economy data of each route and the route number indicating the route are transmitted to the predicted fuel economy data retention section 46, and the predicted fuel economy data of all the found routes and the route numbers are retained therein.

When the comparison function is started, the predicted fuel economy data of all the found routes and the route numbers are input to the predicted fuel economy data comparison section 47 one after another, and the input predicted fuel economy data is compared with each other in sequence, whereby the predicted fuel economy data of the lowest fuel consumption and the corresponding route number are output to the display section 16.

The predicted fuel economy data of the lowest fuel consumption can be displayed on the display section 16 together with the corresponding route.

The tentative toll retention section 44 retains all tentative tolls calculated by the toll collection apparatus 6 for a plurality of routes and outputs the tentative tolls and the route numbers to the route selection list preparation section 45.

The route selection list preparation section 45 prepares a route selection list for listing the tentative tolls retained in the tentative toll retention section 44 and sends the route selection list data of the route selection list to the display section 16.

In addition to the route number of each route and the tentative toll, the required run time for the automobile to arrive at the destination from the current position when the route is used is displayed on the route selection list displayed on the display section 16.

The selecter of the driver, etc., can select any one of the route numbers in the route selection list displayed on the display section 16, thereby selecting the route.

The navigation system 5 comprises a drive for driving a record medium such as a CD-ROM. A terminal processing program for a mobile terminal, stored on the record medium is installed in a computer, whereby the computer is provided with the functions of performing the navigation processing and the fuel economy data preparation processing as described above.

On the other hand, the toll collection apparatus 6 recognizes each of a large number of automobiles 2 entering the toll collection area, calculates the toll for each automobile 2, and collects the toll.

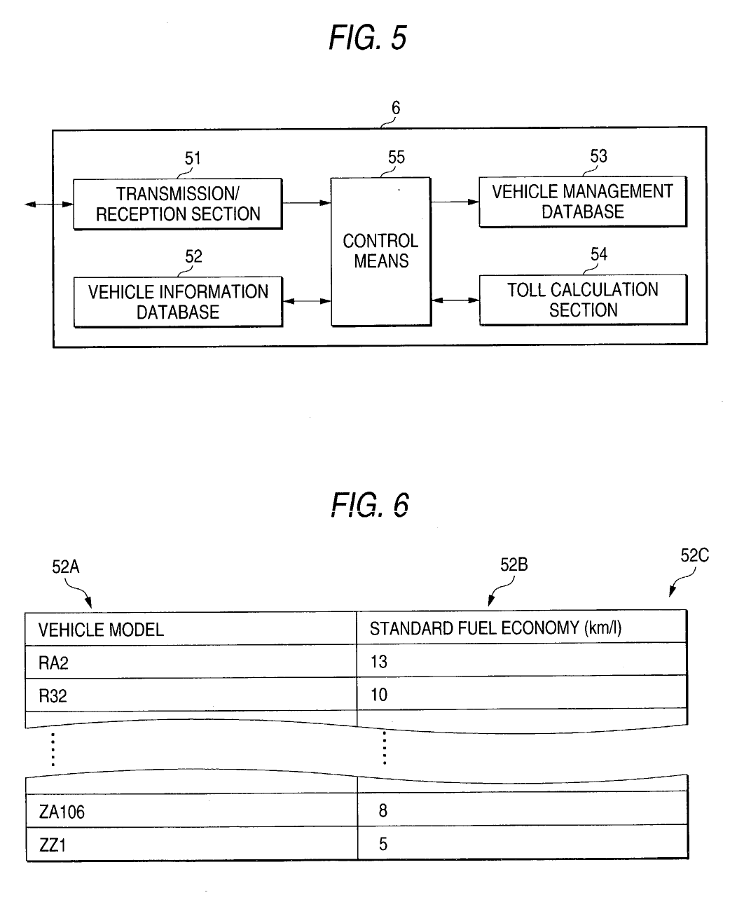

That is, as shown in FIG. 5, the toll collection apparatus 6 comprises a transmission/reception section 51 for communicating with the navigation system 5 through the fixed terminal 4, a vehicle information database 52 accumulating the fuel economy data for all models of the automobiles 2 registered, a vehicle management database 53 accumulating the data of the identification numbers of the navigation systems 5 installed in the automobiles 2 registered, the model numbers of the automobiles 2, and the toll payment methods, for example, credit companies, the credit numbers, etc., and a toll calculation section 54 for calculating the toll from the fuel economy data of each automobile 2 and calculating the tentative toll from the predicted fuel economy data.

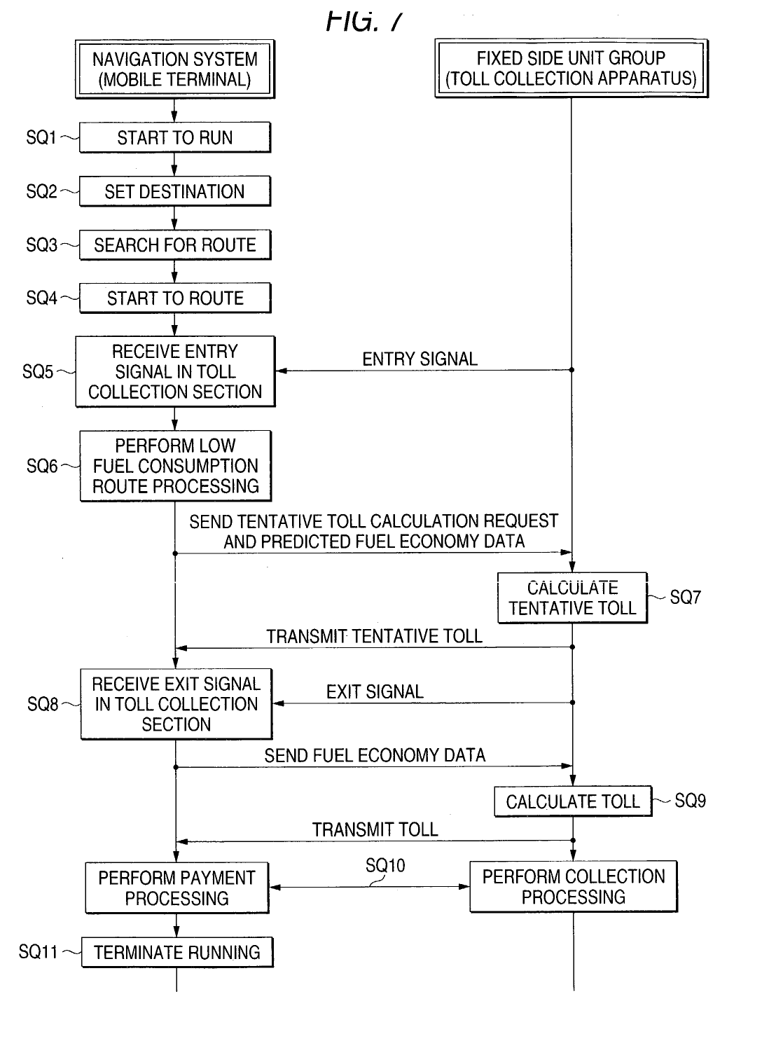

As shown in FIG. 6, the vehicle information database 52 is provided with a fuel economy table 52C comprising a model column 52A entering the vehicle model symbol indicating the model of each automobile 2 and a data column 52B corresponding to the vehicle model symbol under the column 52A and entering the standard fuel economy data of the automobile 2 indicated by the vehicle model symbol.

The value found by the experiment of actually driving the automobile under the standard driving conditions by the automobile manufacturer, etc., is adopted as the standard fuel economy data entered under the data column 52B.

To calculate the toll of each automobile 2, a predetermined operational expression is registered in the toll calculation section 54. When the fuel economy data value transmitted from the automobile 2 is larger than the standard fuel economy data value, the toll calculation section 54 calculates a higher toll than the standard toll; when the fuel economy data value is smaller than the standard fuel economy data value, the toll calculation section 54 calculates a lower toll than the standard toll.

For example, the following expression 1 can be adopted as an operational expression for calculating the toll:

F=(CS/CF)×100+T(yen) (Expression 1)

where F, CS, CF, and T are the toll, the standard fuel economy data value, the fuel economy data value, and the standard toll respectively.

Adopting such an operational expression, when the standard toll T is 100 yen, the toll calculation section 54 determines that the toll F is 200 yen when the fuel economy data value is equal to the standard fuel economy data value; the toll calculation section 54 determines that the toll F is 300 yen when the fuel economy data value is twice the standard fuel economy data value; and the toll calculation section 54 determines that the toll F is 150 yen when the fuel economy data value is half the standard fuel economy data value.

The toll calculation section 54 calculates a tentative toll in a similar manner to that of calculating the toll described above. For example, the predicted fuel economy data value is assigned to Expression 1 in place of the fuel economy data value in Expression 1, whereby the tentative toll can be found.

Here, the transmission/reception section 51 serves as a tentative toll transmission unit for transmitting the calculated tentative toll to the navigation system 5.

Next, the operation of the toll collection system 1 of the embodiment will be discussed with reference to a sequence chart of FIG. 7.

As shown in FIG. 7, when the automobile 2 starts to run in sequence SQ1 and a destination is set for the navigation system 5 in sequence SQ2, the navigation system 5 makes a search for a route from the current point to the destination in sequence SQ3. When the navigation system 5 finds the optimum route, it makes a transition to sequence SQ4 and routes the automobile so as to proceed along the found route.

In sequence SQ5 wherein the automobile 2 enters the toll collection section, the navigation system 5 receives an entry signal from the fixed side unit group 7. In sequence SQ6, the navigation system 5 starts to measure fuel economy and executes fuel economy prediction processing for making a search for low fuel consumption routes. When the navigation system 5 finds several low fuel consumption routes, it sends a tentative toll calculation request and calculated predicted fuel economy data to the fixed side unit group 7.

Upon reception of the calculation request and the predicted fuel economy data, the toll collection apparatus 6 in the fixed side unit group 7 calculates a tentative toll based on the predicted fuel economy data in sequence SQ7 and transmits the calculated tentative toll to the navigation system 5.

The sequences SQ5 to SQ7 are executed promptly while the automobile 2 runs in the proximity of the entrance gate 3.

The navigation system 5 presents several found low fuel consumption routes and the corresponding tentative tolls for the driver, etc. When one of the presented low fuel consumption routes is selected, the navigation system 5 routes the automobile so as to proceed along the selected low fuel consumption route.

Further, in sequence SQ8 wherein the automobile 2 exits the toll collection section, upon reception of an exit signal from the fixed side unit group 7, the navigation system 5 terminates the fuel economy measurement and calculates fuel economy data from the actually traveled distance and the actual fuel consumption amount and sends the fuel economy data to the fixed side unit group 7.

Then, in sequence SQ9, the toll collection apparatus 6 calculates the toll and sends the calculated toll to the navigation system 5. Then, in sequence SQ10, the navigation system 5 and the toll collection apparatus 6 perform payment processing and collection processing respectively and the payment processing and the collection processing are complete.

The sequences SQ8 to SQ10 are executed promptly while the automobile 2 runs in the proximity of the exit gate 3.

In sequence SQ11 wherein the automobile 2 arrives at the destination and terminates running, the sequences are complete.

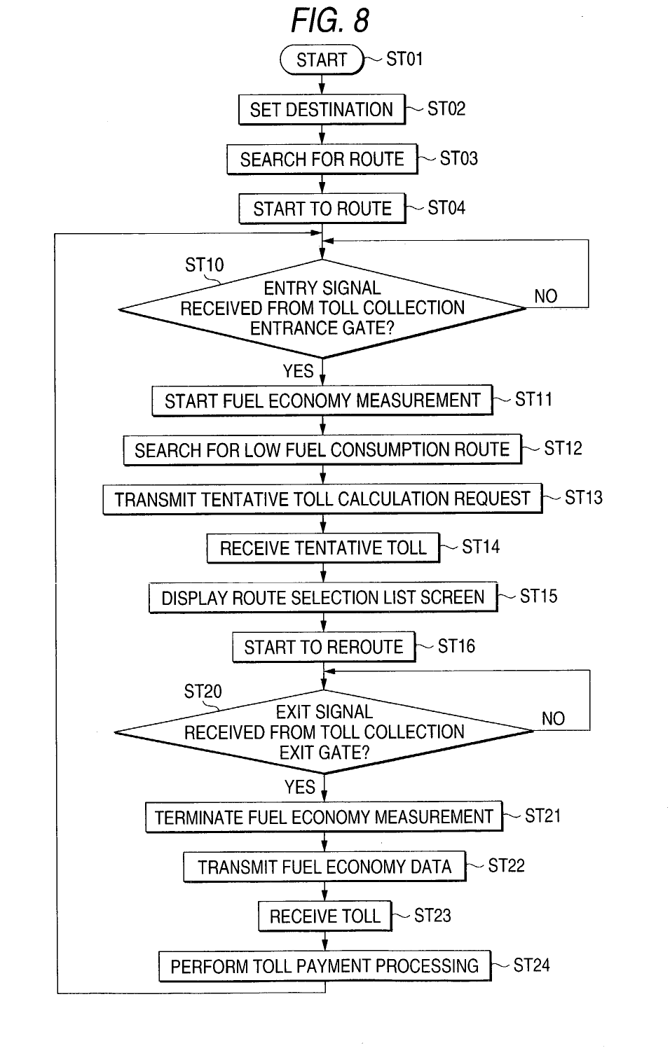

Next, the operation of the navigation system 5 of the embodiment will be discussed with reference to a flowchart of FIG. 8.

As shown in FIG. 8, at step ST01, when the automobile 2 is started, the navigation system 5 is also started. When a destination is set for the navigation system 5 at step ST02, the navigation system 5 makes a search for a route from the current point to the destination at step ST03. When the navigation system 5 finds the optimum route, it makes a transition to step ST04 and routes the automobile so as to proceed along the found route.

At step ST10, the navigation system 5 waits until the automobile 2 enters the toll collection section and an entry signal is received from the fixed side unit group 7. Upon reception of the entry signal, the navigation system 5 goes to step ST11 and starts fuel economy measurement of measuring the traveled distance and the fuel consumption amount and then goes to step ST12.

At step ST12, the navigation system 5 makes a search for a low fuel consumption route with a small fuel consumption amount and predicts the fuel consumption amount required for running on the low fuel consumption route and the traveled distance to find predicted fuel economy data.

When the navigation system 5 finds several low fuel consumption routes, it goes to step ST13 and sends a tentative toll calculation request and the calculated predicted fuel economy data to the fixed side unit group 7. At step ST14, the navigation system 5 receives the tentative toll of each low fuel consumption route and at step ST15, displays a route selection list screen indicating the tentative tolls of the low fuel consumption routes and the like, requesting the driver, etc., to select one of the low fuel consumption routes.

Upon determination of the low fuel consumption route on which the automobile should proceed, the navigation system 5 goes to step ST15 and routes the automobile so as to proceed along the determined low fuel consumption route.

At ST20, the navigation system 5 waits until the automobile 2 exits the toll collection section and an exit signal is received from the fixed side unit group 7. Upon reception of the exit signal, the navigation system 5 goes to step ST21 and terminates the fuel economy measurement and calculates the fuel economy data. Upon completion of calculating the fuel economy data, the navigation system 5 goes to step S22 and sends the calculated fuel economy data to the fixed side unit group 7.

Then, at step ST23, the navigation system 5 receives the toll transmitted from the toll collection apparatus 6. At step ST24, the navigation system 5 performs payment processing. Upon completion of the payment processing, the navigation system 5 returns to step ST10 and repeats steps ST10 to ST24 until the automobile 2 arrives at the destination and terminates running and the navigation system 5 is powered off.

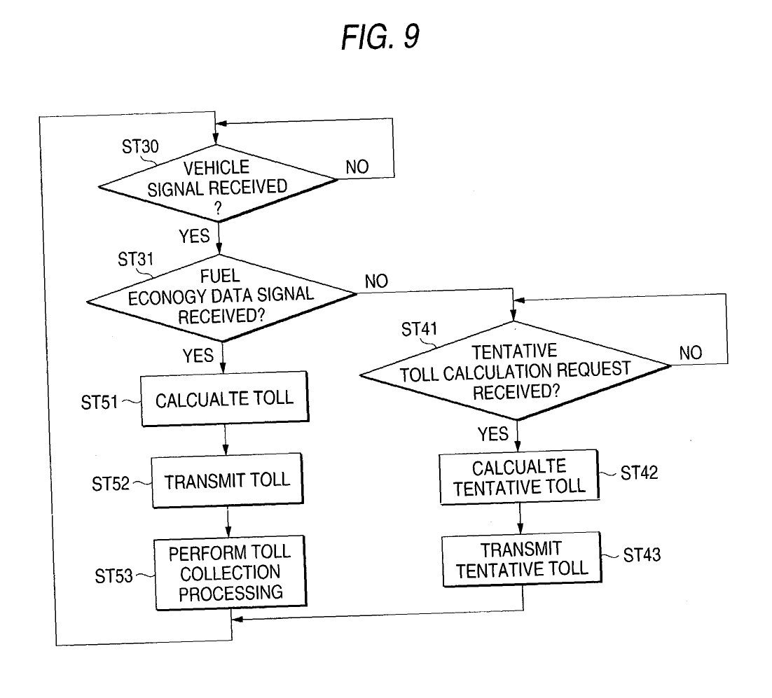

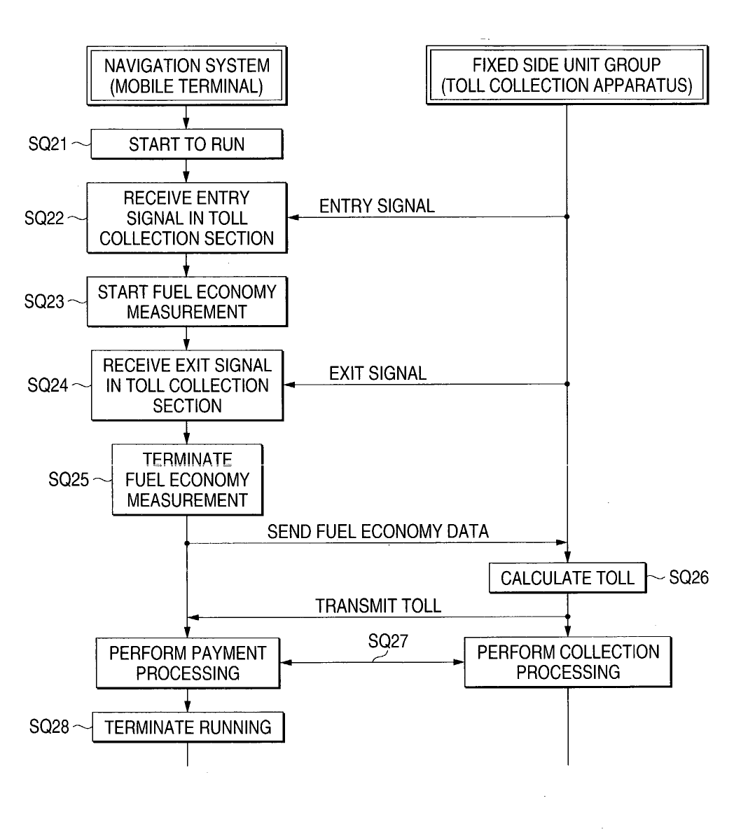

Next, the operation of the toll collection apparatus 6 of the embodiment will be discussed with reference to a flowchart of FIG. 9.

As shown in FIG. 9, at step ST30, the toll collection apparatus 6 waits until the automobile 2 passes through the entrance or exit gate 3 and a vehicle signal provided by ORing an entry signal and an exit signal is received from the fixed terminal 4. Upon reception of the vehicle signal, the toll collection apparatus 6 goes to step ST31. At this time, the identification number as well as the vehicle signal is received and thus the automobile 2 passing through the gate 3 is identified individually.

At step ST31, whether or not fuel economy data is transmitted from the automobile 2 passing through the gate 3 is determined. If fuel economy data is not transmitted, it means that the automobile 2 enters the toll collection section and thus the toll collection apparatus 6 goes to step ST41.

On the other hand, if it is determined at step ST31 that fuel economy data is transmitted, it means that the automobile 2 exits the toll collection section and thus the toll collection apparatus 6 goes to step ST51.

At step ST41, the toll collection apparatus 6 waits until a tentative toll calculation request signal comes from the navigation system 5. Upon reception of the tentative toll calculation request signal, the toll collection apparatus 6 goes to step ST42.

At step ST42, the toll collection apparatus 6 calculates a tentative toll based on predicted fuel economy data received together with the calculation request signal and at step ST43, transmits the calculated tentative toll to the navigation system 5. Upon completion of transmitting the tentative toll, the toll collection apparatus 6 returns to step ST30.

On the other hand, at step ST51, the toll collection apparatus 6 calculates the toll based on the received fuel economy data and at step ST52, transmits the calculated toll to the navigation system 5. Upon completion of transmitting the toll, the toll collection apparatus 6 performs toll collection processing at step ST53. Upon completion of the collection processing, the toll collection apparatus 6 returns to step ST30.

The operation of the toll collection apparatus 6 as described above is repeated until the toll collection system 1 stops.

According to the first embodiment as described above, the following advantages are provided:

The fuel economy data of the automobile 2 is adopted as the run data used as an index indicating the magnitude of the effect on the environment as the automobile 2 runs, and the navigation system 5 calculates the fuel economy data of the automobile 2 and transmits the fuel economy data to the toll collection apparatus 6, so that the toll is calculated based on the fuel economy data and the toll responsive to how the driver drives the automobile in a gentle manner can be imposed.

Since the toll responsive to how the driver drives the automobile in a gentle manner is imposed, if the driver drives the automobile so as to emit a larger amount of exhaust gas, the toll to be paid is raised; in contrast, if the driver drives the automobile so as to more lessen the emission amount of exhaust gas, the toll to be paid is reduced. Thus, the driver can be prompted to drive so as to lessen the effect on the environment as the vehicle runs as much as possible, and improvement in the air quality can be insured.

The fuel economy data calculated based on the traveled distance data easily taken out from a speed meter, etc., and the fuel consumption amount data easily taken out from a fuel injection system, etc., is adopted as the run data, so that if the fuel economy data is collected from the existing automobile 2, remolding of the automobile 2 can be minimized and the price of a vehicle fitted for the toll collection system and the remolding cost to fit a vehicle for the toll collection system are not raised.

Further, if the fuel economy data is referenced, the emission amount of environmental pollutants and the emission amount of greenhouse gases discharged from the automobile 2 as the automobile 2 runs can be grasped and the magnitude of the effect on the environment as the automobile 2 runs can be easily converted into a numerical value, so that an appropriate toll can be collected from the automobile 2.

As the mobile terminal of the toll collection system 1, the navigation system 5 installing a microprocessor that can perform various operations at high speed is adopted, so that the collection function of the traveled distance data and the fuel consumption amount data, the calculation function of calculating the fuel economy data from the traveled distance data and the fuel consumption amount data, the transmission function of the fuel economy data, and the like can be provided easily.

Moreover, vehicle-installed navigation systems are widespread and thus from this point, the price of the automobile 2 fitted for the toll collection system and the remolding cost to fit the automobile 2 for the toll collection system are not raised.

Further, the navigation system 5 comprising the navigation processing section 32 for making a search for a route to the destination, the fuel economy prediction calculation section 42 for predicting the fuel economy by calculating when running on the route for each found route, and the low fuel consumption route search section 43 for making a search for the lowest fuel consumption route based on the prediction result of the fuel economy prediction calculation section 42 is adopted, so that a route lessening the effect on the environment as the automobile runs can be found, and the low fuel consumption route can be presented for the driver. If the driver drives the automobile in accordance with the route indicated by the navigation system 5, improvement in the air quality can be still more insured.

The navigation system 5 is provided with the transmission/reception section 20 for transmitting the predicted fuel economy data found by calculating by the fuel economy prediction calculation section 42 to the toll collection apparatus 6, and the toll collection apparatus 6 is provided with the toll calculation section 54 that can calculate a tentative toll based on the received predicted fuel economy data and the transmission/reception section 51 for transmitting the calculated tentative toll to the navigation system 5. The navigation system 5 makes a search for a plurality of low fuel consumption routes, the toll collection apparatus 6 calculates the tentative toll for each of the routes, and the low fuel consumption routes are displayed, so that the driver selects the lowest-toll route, in other words, the route with the smallest effect on the environment as the automobile runs unless a special situation or reason exists. Thus, improvement in the air quality can be still more insured.

Further, the program for causing a computer to execute the functions of performing the navigation processing and the fuel economy data preparation processing in the first embodiment is recorded on a record medium such as a CD-ROM and is installed in the navigation system 5, whereby the mobile terminal is implemented. Thus, without drastically remolding the navigation system 5 having no function of the mobile terminal, the mobile terminal having the functions can be manufactured easily and a large number of mobile terminals can also be manufactured easily.

FIGS. 10 to 12 show the operation of a second embodiment of the invention.

The second embodiment is provided by removing the fuel economy prediction calculation section 42, the low fuel consumption route search section 43, the tentative toll retention section 44, and the route selection list preparation section 45 from the fuel economy data preparation processing section 33 in the first embodiment.

The operation of a toll collection system 1 of the second embodiment will be discussed with reference to a sequence chart of FIG. 10.

As shown in FIG. 10, an automobile 2 starts to run in sequence SQ21 and in sequence SQ22 wherein the automobile 2 enters a toll collection section, a navigation system 5 receives an entry signal from a fixed side unit group 7 and in sequence SQ23, starts to measure fuel economy.

In sequence SQ24 wherein the automobile 2 exits the toll collection section, upon reception of an exit signal from the fixed side unit group 7, the navigation system 5 terminates the fuel economy measurement in sequence SQ25 and calculates fuel economy data from the actually traveled distance and the actual fuel consumption amount and sends the fuel economy data to the fixed side unit group 7.

Then, in sequence SQ26, a toll collection apparatus 6 calculates the toll and sends the calculated toll to the navigation system 5. Then, in sequence SQ27, the navigation system 5 and the toll collection apparatus 6 perform payment processing and collection processing respectively and the payment processing and the collection processing are complete.

The sequences SQ24 to SQ27 are executed promptly while the automobile 2 runs in the proximity of an exit gate 3.

In sequence SQ28 wherein the automobile 2 arrives at the destination and terminates running, the sequences are complete.

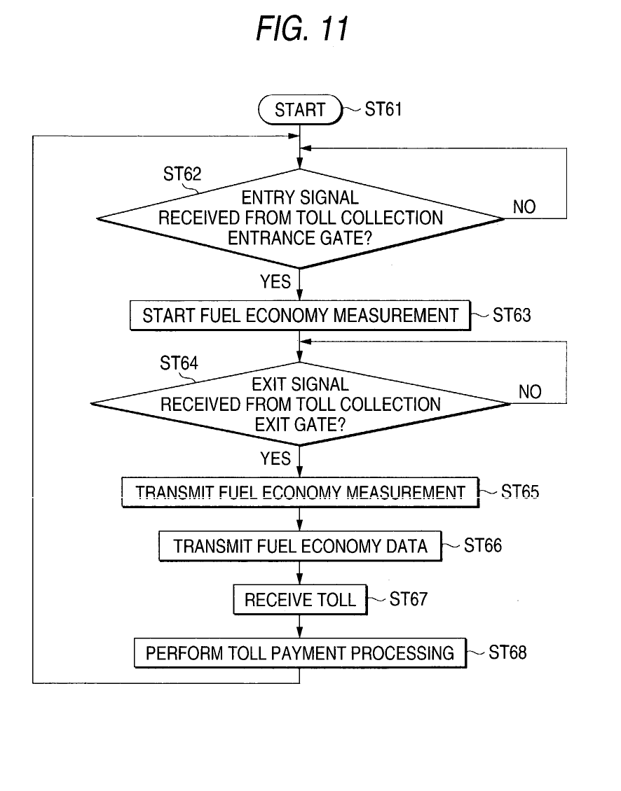

Next, the operation of the navigation system 5 of the embodiment will be discussed with reference to a flowchart of FIG. 11.

As shown in FIG. 11, at step ST61, when the automobile 2 is started, the navigation system 5 is also started. At step ST62, the navigation system 5 waits until the automobile 2 enters the toll collection section and an entry signal is received from the fixed side unit group 7. Upon reception of the entry signal, the navigation system 5 goes to step ST63 and starts fuel economy measurement of measuring the traveled distance and the fuel consumption amount and then goes to step ST64.

At step ST64, the navigation system 5 waits until the automobile 2 exits the toll collection section and an exit signal is received from the fixed side unit group 7. Upon reception of the exit signal, the navigation system 5 goes to step ST65 and terminates the fuel economy measurement and calculates the fuel economy data. Upon completion of calculating the fuel economy data, the navigation system 5 goes to step S66 and sends the calculated fuel economy data to the fixed side unit group 7.

Then, at step ST67, the navigation system 5 receives the toll transmitted from the toll collection apparatus 6. At step ST68, the navigation system 5 performs payment processing. Upon completion of the payment processing, the navigation system 5 returns to step ST62 and repeats steps ST62 to ST68 until the automobile 2 arrives at the destination and terminates running and the navigation system 5 is powered off.

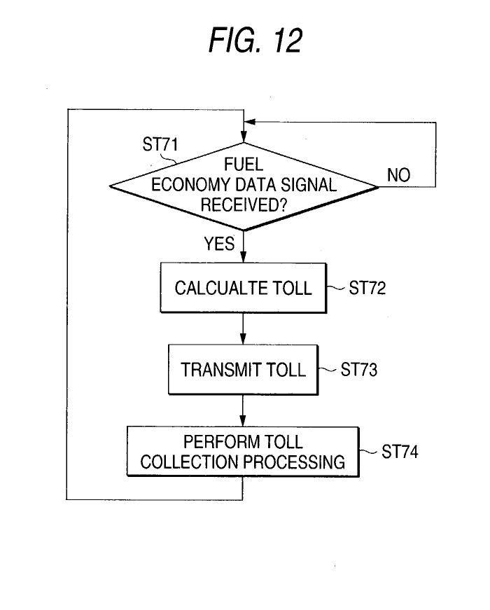

Next, the operation of the toll collection apparatus 6 of the embodiment will be discussed with reference to a flowchart of FIG. 12.

As shown in FIG. 12, at step ST71, the toll collection apparatus 6 waits until the automobile 2 passes through the gate 3 and fuel economy data is transmitted from the automobile 2. When the fuel economy data is transmitted, the toll collection apparatus 6 goes to step ST72.

At step ST72, the toll collection apparatus 6 calculates the toll based on the received fuel economy data and at step ST73, transmits the calculated toll to the navigation system 5. Upon completion of transmitting the toll, the toll collection apparatus 6 performs toll collection processing at step ST74. Upon completion of the collection processing, the toll collection apparatus 6 returns to step ST71.

The operation of the toll collection apparatus 6 as described above is repeated until the toll collection system 1 stops.

In the second embodiment, advantages similar to those in the first embodiment can also be accomplished except the advantages provided by the fuel economy prediction calculation section 42, the low fuel consumption route search section 43, the tentative toll retention section 44, and the route selection list preparation section 45 in the first embodiment.

The invention is not limited to the above-described embodiments and also includes the following modifications, etc.:

For example, the toll collection system is not limited to the system comprising the communication unit for conducting communications between the toll processing apparatus and the mobile terminal through the fixed terminal and a toll collection system comprising a wide-area mobile communication unit of a mobile telephone, etc., aside from the communication unit through the fixed terminal may be adopted.

If such a toll collection system comprising a wide-area mobile communication unit is adopted, the mobile terminal can transmit a tentative toll calculation request to the toll processing apparatus even if it is at a position at a distance from a gate and out of the communication range of the fixed terminal. If the route is changed at a distant location from the gate, the tentative toll of the route can be known.

The run data used as the index indicating the magnitude of the effect on the environment as a vehicle runs is not limited to the fuel economy data of the vehicle; a measuring instrument for measuring the emission amounts of environmental pollutants and greenhouse gases discharged from a vehicle may be attached to a vehicle and the emission amounts of environmental pollutants and greenhouse gases discharged as the vehicle runs may be adopted as the run data.

Further, the vehicle is not limited to an automobile having four or more wheels and may be an autobicycle or an automobile having three wheels; if the vehicle is a vehicle having an internal combustion engine for running on a road, the model, etc., of the vehicle is not limited.

As described above, according to the invention, it is made possible to impose a toll responsive to how the driver drives the vehicle in a gentle manner in a predetermined area, and a decrease in the effect on the environment as the vehicle runs can be promoted.

What is claimed is:

1. A toll collection system wherein gates are placed in the boundaries of a predetermined area and a vehicle passing through the inside and entering the area is detected at the gate for collecting a toll from the vehicle, said toll collection system comprising:
fixed terminals each being placed in the proximity of each gate and capable of communicating with a mobile unit passing through the vicinity thereof;
a mobile terminal being installed in a vehicle for collecting run data used as an index indicating the magnitude of the effect on the environment as the vehicle runs from the vehicle and transmitting the run data to said fixed terminal; and
a toll processing apparatus for receiving the run data of each vehicle through said fixed terminal and calculating the toll of each vehicle based on the received run data.

2. The toll collection system as claimed in claim 1 wherein said mobile terminal collects traveled distance data and fuel consumption amount data from the vehicle, calculates fuel economy data of the vehicle from the traveled distance data and the fuel consumption amount data, and transmits the fuel economy data to said fixed terminal as the run data, and
wherein said toll processing apparatus comprises a standard fuel economy database recording standard fuel economy data under a standard run condition found for each model of vehicle, compares the fuel economy data from each vehicle with the standard fuel economy data of the vehicle, and calculates the toll of the vehicle based on the comparison result.

3. The toll collection system as claimed in claim 2 wherein said mobile terminal comprises a navigation system for receiving current position information to measure the current position of the mobile unit and displaying the current position on a screen of a display based on stored map information.

4. The toll collection system as claimed in claim 3 wherein the navigation system comprises a route search unit for making a search for a route to a destination, a fuel economy prediction unit for predicting the fuel economy by calculating when running on the route for each found route, and a low fuel consumption route search unit for making a search for a low fuel consumption route based on the prediction result of the fuel economy prediction unit.

5. The toll collection system as claimed in claim 4 wherein the navigation system comprises a predicted fuel economy transmission unit for transmitting the predicted fuel economy data provided by calculating by the fuel economy prediction unit to said toll processing apparatus, and
wherein said toll processing apparatus comprises a tentative toll transmission unit for receiving the predicted fuel economy data, calculating a tentative toll based on the received predicted fuel economy data, and transmitting the calculated tentative toll to the navigation system.

6. A mobile terminal installed in a toll collection system wherein gates are placed in the boundaries of a predetermined area and a vehicle passing through the inside and entering the area is detected at the gate for collecting a toll from the vehicle, the toll collection system comprising:
fixed terminals each being placed in the proximity of each gate and capable of communicating with a mobile unit passing through the vicinity thereof; and
a toll processing apparatus for receiving run data used as an index indicating the magnitude of the effect on the environment as the vehicle runs through the fixed terminal and calculating the toll of the vehicle based on the received run data, said mobile terminal being installed in a vehicle for collecting the run data of the vehicle and transmitting the run data to the fixed terminal.

7. The mobile terminal as claimed in claim 6 wherein the toll processing apparatus comprises a standard fuel economy database recording standard fuel economy data under a standard run condition found for each model of vehicle, compares the fuel economy data from each vehicle with the standard fuel economy data of the vehicle, and calculates the toll of the vehicle based on the comparison result, and
wherein said mobile terminal collects traveled distance data and fuel consumption amount data from the vehicle, calculates fuel economy data of the vehicle from the traveled distance data and the fuel consumption amount data, and transmits the fuel economy data to the fixed terminal as the run data.

8. The mobile terminal as claimed in claim 7, further comprising a navigation system for receiving current position information to measure the current position of the mobile unit and displaying the current position on a screen of a display based on stored map information.

9. The mobile terminal as claimed in claim 8 wherein the navigation system comprises a route search unit for making a search for a route to a destination, a fuel economy prediction unit for predicting the fuel economy by calculating when running on the route for each found route, and a low fuel consumption route search unit for making a search for a low-fuel consumption route based on the prediction result of the fuel economy prediction unit.

10. The mobile terminal as claimed in claim 9 wherein the toll processing apparatus comprises a tentative toll transmission unit for calculating a tentative toll based on the predicted fuel economy data calculated by the navigation system and transmitting the calculated tentative toll to the navigation system, and
wherein the navigation system comprises a predicted fuel economy transmission unit for transmitting the predicted fuel economy data provided by calculating by the fuel economy prediction unit to the toll processing apparatus.

11. A toll processing apparatus installed in a toll collection system wherein gates are placed in the boundaries of a predetermined area and a vehicle passing through the inside and entering the area is detected at the gate for collecting a toll from the vehicle, the toll collection system comprising fixed terminals each being placed in the proximity of each gate and capable of communicating with a mobile unit passing through the vicinity thereof, and a mobile terminal being installed in a vehicle for collecting run data used as an index indicating the magnitude of the effect on the environment as the vehicle runs from the vehicle and transmitting the run data to said fixed terminal, said toll processing apparatus for receiving the run data of each vehicle through the fixed terminal and calculating the toll of each vehicle based on the received run data.

12. The toll processing apparatus as claimed in claim 11 wherein the mobile terminal collects traveled distance data and fuel consumption amount data from the vehicle, calculates fuel economy data of the vehicle from the traveled distance data and the fuel consumption amount data, and transmits the fuel economy data to the fixed terminal as the run data, and
wherein said toll processing apparatus comprises a standard fuel economy database recording standard fuel economy data under a standard run condition found for each model of vehicle, compares the fuel economy data from each vehicle with the standard fuel economy data of the vehicle, and calculates the toll of the vehicle based on the comparison result.

13. The toll processing apparatus as claimed in claim 12 wherein the mobile terminal comprises a navigation system for receiving current position information to measure the current position of the mobile unit and displaying the current position on a screen of a display based on stored map information,
wherein the navigation system comprises a route search unit for making a search for a route to a destination, a fuel economy prediction unit for predicting the fuel economy by calculating when running on the route for each found route, a low fuel consumption route search unit for making a search for a low fuel consumption route based on the prediction result of the fuel economy prediction unit, and a predicted fuel economy transmission unit for transmitting the predicted fuel economy data provided by calculating by the fuel economy prediction unit to the toll processing apparatus, and
wherein said toll processing apparatus comprises a tentative toll transmission unit for receiving the predicted fuel economy data, calculating a tentative toll based on the received predicted fuel economy data, and transmitting the calculated tentative toll to the navigation system.

14. A terminal processing program for a mobile terminal being installed in a vehicle for transmitting predetermined run data to a toll processing apparatus placed in a toll collection system wherein gates are placed in the boundaries of a predetermined area and a vehicle passing through the inside and entering the area is detected at the gate for collecting a toll from the vehicle, the mobile terminal including a computer, said terminal processing program for causing the computer to function as:
a collection unit for collecting traveled distance data and fuel consumption amount data from the vehicle;
a fuel economy calculation unit for calculating fuel economy data of the vehicle from the traveled distance data and the fuel consumption amount data collected by the collection unit; and
a data transmission unit for transmitting the fuel economy data calculated by the fuel economy calculation unit to the toll processing apparatus as the run data.

15. The terminal processing program for the mobile terminal as claimed in claim 14, wherein the mobile terminal including the computer is a navigation system for receiving current position information to measure the current position of the mobile unit from the outside and displaying the current position on a screen of a display based on previously stored map information, said terminal processing program for causing the computer of the navigation system to function as:
a route search unit for making a search for a route to a destination;
a fuel economy prediction unit for predicting the fuel economy by calculating when running on the route for each found route;
a low fuel consumption route search unit for making a search for a low fuel consumption route based on the prediction result of the fuel economy prediction unit; and
a predicted fuel economy transmission unit for transmitting the predicted fuel economy data provided by calculating by the fuel economy prediction unit to the toll processing apparatus.

16. A record medium recording a terminal processing program for a mobile terminal being installed in a vehicle for transmitting predetermined run data to a toll processing apparatus placed in a toll collection system wherein gates are placed in the boundaries of a predetermined area and a vehicle passing through the inside and entering the area is detected at the gate for collecting a toll from the vehicle, the mobile terminal including a computer, the terminal processing program for causing the computer to function as:
a collection unit for collecting traveled distance data and fuel consumption amount data from the vehicle;
a fuel economy calculation unit for calculating fuel economy data of the vehicle from the traveled distance data and the fuel consumption amount data collected by the collection unit; and
a data transmission unit for transmitting the fuel economy data calculated by the fuel economy calculation unit to the toll processing apparatus as the run data.

17. The record medium recording the terminal processing program for the mobile terminal as claimed in claim 16, wherein the mobile terminal including the computer is a navigation system for receiving current position information to measure the current position of the mobile unit from the outside and displaying the current position on a screen of a display based on previously stored map information, the terminal processing program for causing the computer of the navigation system to function as:
a route search unit for making a search for a route to a destination;
a fuel economy prediction unit for predicting the fuel economy by calculating when running on the route for each found route;
a low fuel consumption route search unit for making a search for a low fuel consumption route based on the prediction result of the fuel economy prediction unit; and
a predicted fuel economy transmission unit for transmitting the predicted fuel economy data provided by calculating by the fuel economy prediction unit to the toll processing apparatus.
